(19) United States
(12) Patent Application Publication
(10) Pub. No.: US 2018/0135400 A1
(43) Pub. Date: May 17, 2018

(54) Subsea Reservoir Pressure Maintenance System

(71) Applicants: Paul M. Sommerfield, Giddings, TX (US); Kevin T. Corbett, Missouri City, TX (US); Mohan G. Kulkarni, The Woodlands, TX (US); Kamran Ahmed Gul, Tomball, TX (US)

(72) Inventors: Paul M. Sommerfield, Giddings, TX (US); Kevin T. Corbett, Missouri City, TX (US); Mohan G. Kulkarni, The Woodlands, TX (US); Kamran Ahmed Gul, Tomball, TX (US)

(21) Appl. No.: 15/710,453

(22) Filed: Sep. 20, 2017

Related U.S. Application Data
(60) Provisional application No. 62/423,247, filed on Nov. 17, 2016.

(51) Int. Cl. E21B 43/36; E21B 33/076; E21B 43/16; F04B 43/06

(52) U.S. Cl. CPC E21B 43/36; E21B 33/076; F15B 3/00; F04B 43/06; E21B 43/16

(57) ABSTRACT

A subsea reservoir pressure maintenance system, including: a subsea chemical storage unit; a seawater intake and treatment system that takes in seawater and chemically treats the seawater with a chemical stored in the subsea storage unit, wherein a first subsea seal-less pump transfers the chemical from the subsea chemical storage unit to the seawater intake and treatment system; a second seal-less subsea pump that boosts pressure of the chemically treated seawater received from the seawater intake and treatment system; and a water injection manifold that receives the chemically treated seawater at the boosted pressure and injects the chemically treated seawater into a seabed.

### CROSS REFERENCE TO RELATED APPLICATION

This application claims the benefit of U.S. Provisional Application Ser. No. 62/423,247, filed Nov. 17, 2016, entitled “Subsea Reservoir Pressure Maintenance System,” the disclosure of which is incorporated herein by reference in its entirety.

### TECHNOLOGICAL FIELD

Exemplary embodiments described herein pertain to a system and method for maintaining pressure and flow from reservoirs to the host facility. Specifically, embodiments described herein relate to subsea reservoir pressure and maintenance system that utilizes a seawater intake and treatment system.

### BACKGROUND

This section is intended to introduce various aspects of the art, which may be associated with exemplary embodiments of the present technological advancement. This discussion is believed to assist in providing a framework to facilitate a better understanding of particular aspects of the present technological advancement. Accordingly, it should be understood that this section should be read in this light, and not necessarily as admissions of prior art.

Some production wells require additional assistance in maintaining pressure and flow from their reservoirs to the host facility. Currently, water injection is the most common form of reservoir pressure maintenance system used in the offshore oil and gas industry. Such water injection systems include topside water intake and treatment systems, topside pumps for boosting water and chemicals pressure, large umbilical tubes for hydraulic controls, power and injection chemicals, and water injection flowlines. This configuration of water injection systems is applicable to both subsea wells (FIG. 1A) or platform-based wells (FIG. 1B). Umbilicals can be deployed from topside host facilities to the seabed (ocean floor) to supply control, power/energy, communications and/or chemicals to subsea oil and gas wells, subsea manifolds, and any subsea system requiring remote control.

FIG. 1A depicts host facility 101 extending above the water 102, with umbilical 103 (including hydraulic cables and hoses for chemical injection), water injection line 104, and productions lines 105. Umbilical 103 ends at umbilical termination assembly (UTA) 106, which then connects to subsea distribution units (SDUs) 107, in order to provide hydraulic power and/or chemicals to water injection manifold 108 (a subsea structure containing a network of valves and pipework designed to direct injection fluids to one or more subsea wells) and production manifold 109 (a subsea structure containing valves and pipework designed to commingle and direct produced fluids from multiple wells into one or more flowlines) via trees 110 (an assembly of valves, spools, pressure gauges, and chokes to control production or hydrocarbons or injection of water). Water injection line 104 is connected to the water injection manifold via pipeline end termination (PLET) 111. The production lines 105 are connected to the production manifold 109 via flow line termination (FLET) 112. FIG. 1B is similar to FIG. 1A, except it includes platform based wells 108. The systems depicted in FIGS. 1A and 1B both have water injection from the host facility via water injection line 104.

### SUMMARY

A subsea reservoir pressure maintenance system, including: a subsea chemical storage unit; a seawater intake and treatment system that takes in seawater and chemically treats the seawater with a chemical stored in the subsea chemical storage unit, wherein a first subsea seal-less pump transfers the chemical from the subsea chemical storage unit to the seawater intake and treatment system; a second seal-less subsea pump that boosts pressure of the chemically treated seawater received from the seawater intake and treatment system; and a water injection manifold that receives the chemically treated seawater at the boosted pressure and injects the chemically treated seawater into a seabed.

The system can further include an electrical power system that supplies electrical power to the seawater intake and treatment system, the first subsea seal-less pump, the second sub-sea seal-less pump, and the water injection manifold.

In the system, the seawater intake and treatment system and the subsea chemical storage units are disposed on the seabed.

The system can further include a communication system that includes fiber-optic communication cable between a top-side or shore-based hydrocarbon facility and at least the seawater intake and treatment system.

The system can further include an all-electric control system that operates subsea equipment, including the seawater intake and treatment system, a pump, a tree, and a manifold.

The system can further include a single umbilical, which houses an all-electric control system cables, power cables and the fiber-optic communication cables, that connect to a top-side or shore-based hydrocarbon facility.

The system can further include a pressure sensor disposed at least at the first or second seal-less subsea pump, a temperature sensor disposed at a water intake port of the seawater intake and treatment system, a flow sensor, and a vibration sensor, wherein each makes optical measurements and communicates with electronic components via the fiber-optic communications cable to the top-side or shore based hydrocarbon facility.

The system can further include a processor that receives measurements from the pressure sensor, the temperature sensor, the flow sensor, and the vibration sensor and uses the measurements in a feedback or feed-forward control process to control performance of the seawater intake and treatment system.

In the system, the first seal-less pump and the second seal-less pump are different seal-less pumps.

A method, including: storing a chemical in a subsea storage unit; treating seawater with a seawater intake and treatment system, wherein the treating includes taking in seawater with the seawater intake and treatment system and chemically treating the seawater with the chemical stored in the subsea storage unit, and the treating includes using a first subsea seal-less pump to transfer the chemical from the subsea chemical storage unit to the seawater intake and treatment system; boosting pressure, with a second seal-less subsea pump, of the chemically treated seawater received from the seawater intake and treatment system; and injecting the chemically treated seawater into a seabed with a water injection manifold that receives the chemically treated seawater at the boosted pressure.

The method can further include controlling subsea equipment with an all-electric control system.

The method can further include using a fiber optics communication system to communicate between topside equipment and subsea equipment.

The method can further include measuring variables using optic based sensors.

The method can further include providing electrical power, with an electrical power system, to the seawater intake and treatment system, the first subsea seal-less pump, the second sub-sea seal-less pump, and the water injection manifold.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIG. 1A illustrates a water injection system used with subsea wells.

FIG. 1B illustrates a water injection system used with platform based wells.

FIG. 2A illustrates a non-limiting embodiment of the present technological advancement where the water injection flow line has been eliminated.

FIG. 2B illustrates a non-limiting embodiment of the present technological advancement where the water injection flow line has been eliminated and power and control lines have been combined into a single umbilical.

FIG. 2C illustrates a non-limiting embodiment of the present technological advancement is used with platform based wells and a single umbilical for power and communication cables.

FIG. 3 illustrates an exemplary method of extracting hydrocarbons with the present technological advancement.

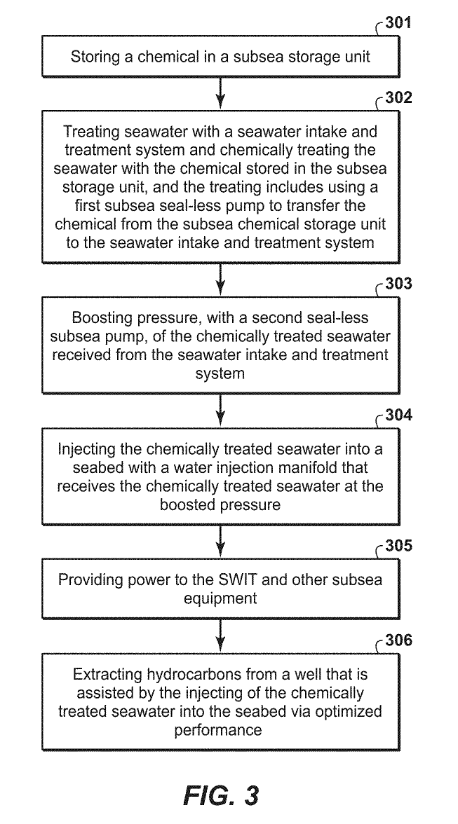

### DETAILED DESCRIPTION

Exemplary embodiments are described herein. However, to the extent that the following description is specific to a particular embodiment, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The CAPEX for conventional water injection systems can be comparable or as high as subsea or surface hydrocarbon production systems. The present technological advancement can provide means to increase capital efficiency by utilizing multiple combinations of subsea technologies to reduce or eliminate topside space requirements and streamline equipment designs.

The present technological advancement can include a subsea reservoir pressure maintenance system that includes: a seawater intake and treatment system (SWIT) to be used at the seabed to take in water and treat it for injection; subsea pumps to boost water pressure; and any combination of subsea equipment (manifold, trees, jumpers etc.) to inject the treated water at the seabed.

A subsea reservoir pressure maintenance system embodying the present technological advancement can eliminate the need for water injection flowline(s) and associated maintenance requirements including corrosion inhibition. The system also reduces the host size, topside equipment footprint, complexity, weight and cost. Further, the next generation subsea reservoir pressure maintenance system embodying the present technological advancement can use subsea chemical storage units and subsea pumps to store and inject the chemicals required for water treatment. One place for chemical injection is the SWIT unit. Chemicals for water treatment can include chlorination, sulfate removal, and/or biocide dosing. Other chemicals used for subsea production systems include MeOH, corrosion inhibitors, asphaltene inhibitor, scale inhibitor, etc. The subsea chemical storage units can store enough chemical for a given period and can be refilled periodically using a shuttle tank. Subsea storage of chemicals will eliminate the need for injection chemical umbilical tube(s). This further reduces the host size, topside equipment footprint, complexity, weight and cost.

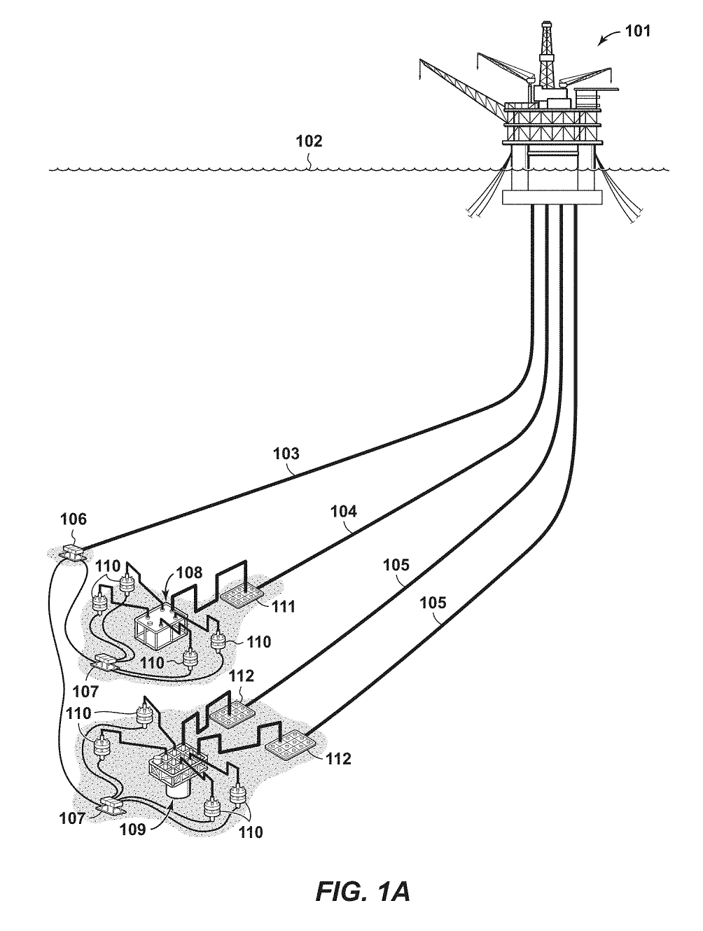

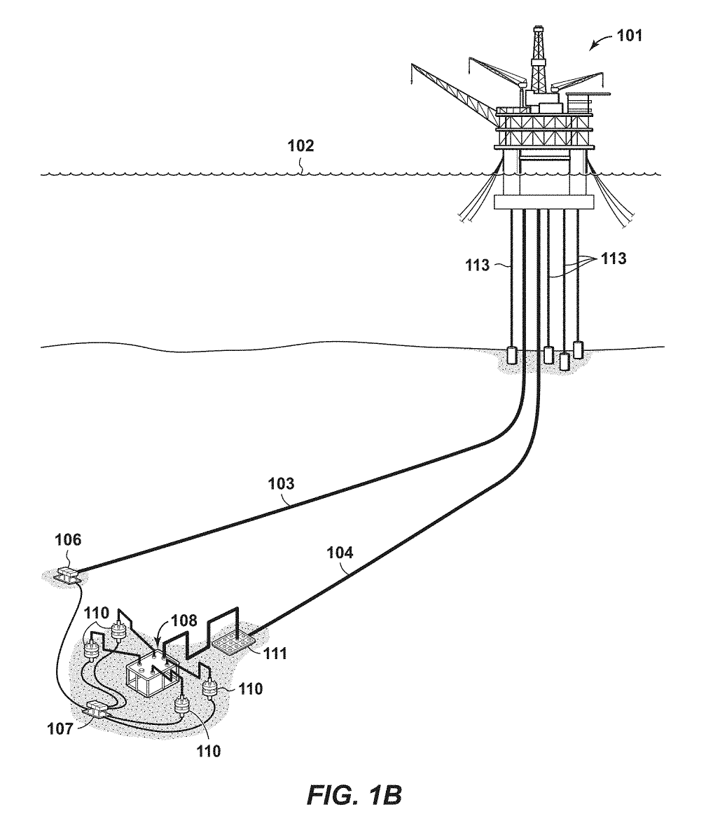

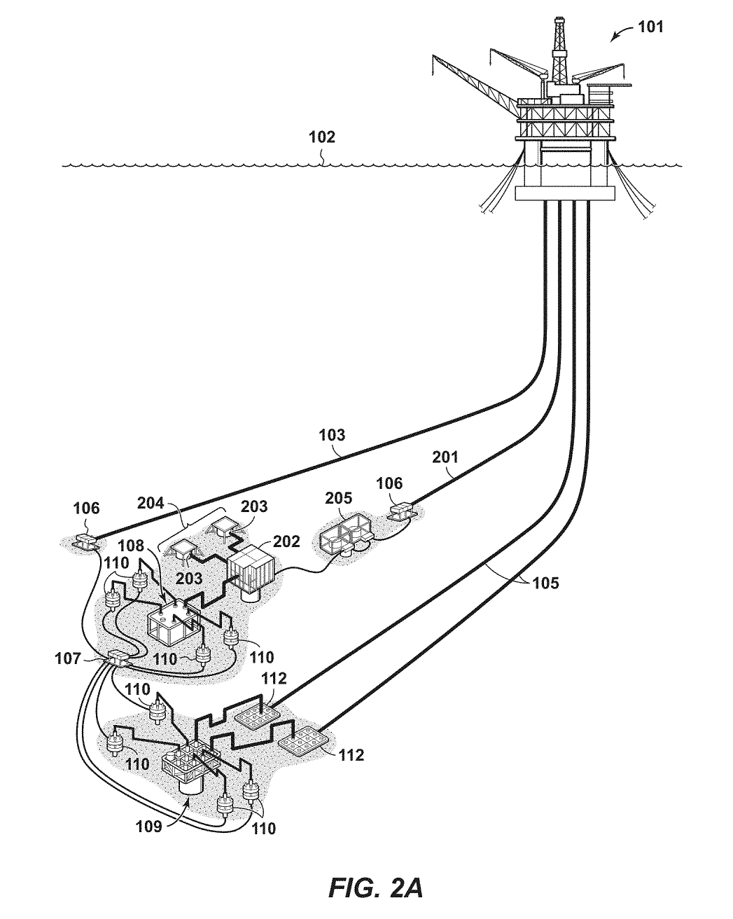

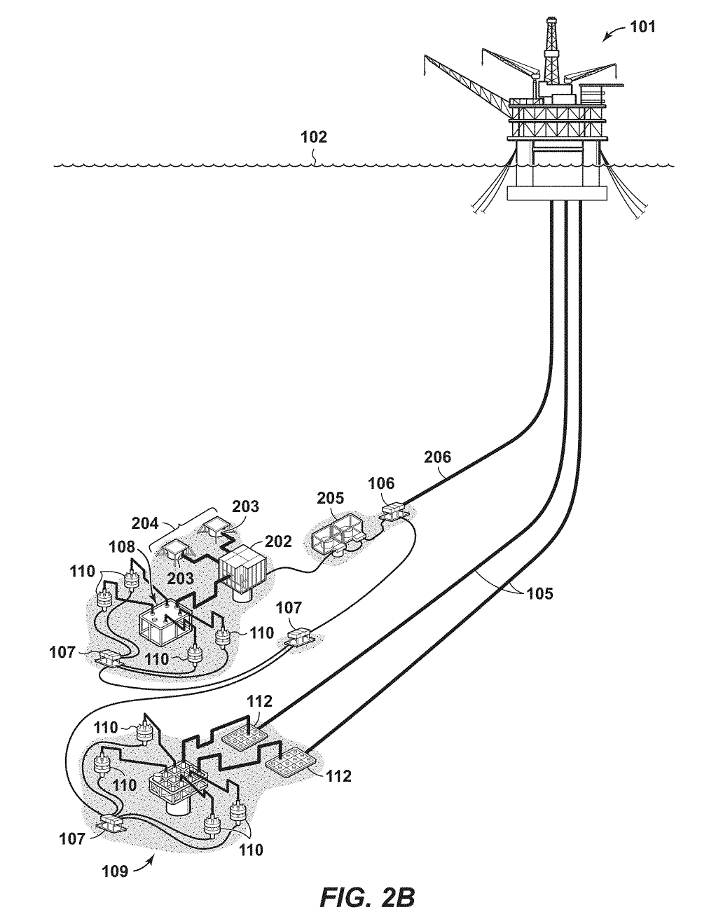

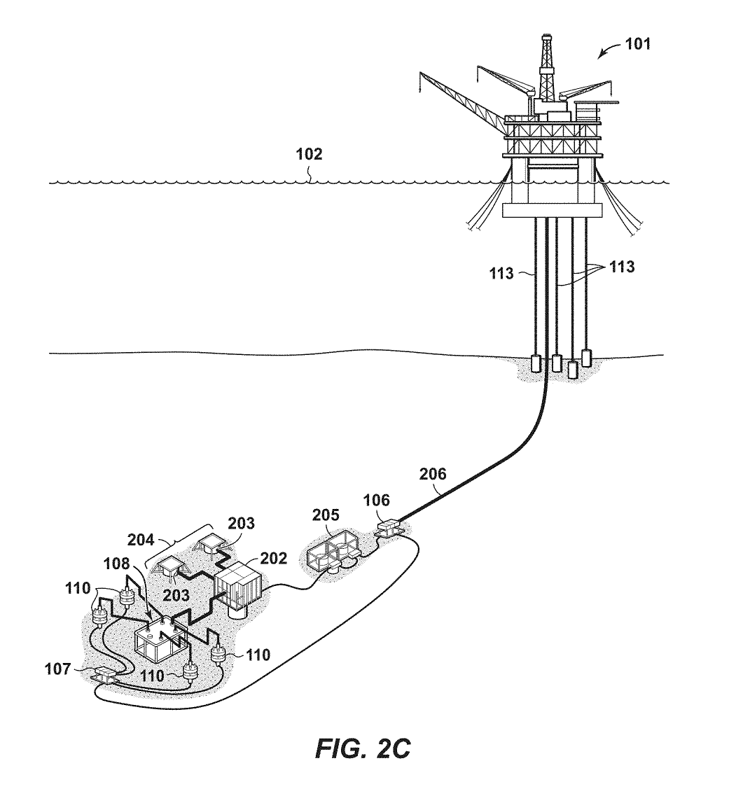

FIG. 2A illustrates a non-limiting embodiment of the present technological advancement where the water injection flow line has been eliminated (compare FIG. 1A to 2A). The host facility 101 is connected to subsea equipment via umbilical 103, production lines 105, and power umbilical 201. Umbilical 103 can include communication and hydraulic tubes. A separate power umbilical 201 is included for the pumps and SWIT. SWIT 202 and the other subsea equipment can be electrically controlled instead of hydraulically. The host facility 101 could be a semi-submersible, spar, tension-leg platform, other floating structure, gravity based structure, other bottom founded structure, or onshore facility for processing, storing, and/or extracting hydrocarbons. Not all possible variations of the facility are shown in the figures. As used herein, an umbilical or umbilical cable is cable and/or hose which supplies required consumables to an apparatus.

The system shown in FIG. 2A can use pumps 203 for boosting water pressure and/or chemical injection. There can be a pump used for injection of subsea stored chemicals and a separate pump used for boosting water pressure. However, it can be possible to design architecture in such a way that only one pump is used for both chemical injection and boosting of water pressure. The pumps can be conventional single phase subsea pumps currently available. Alternatively, additional improvements in the life-cycle cost and reliability of the system can be obtained through the use of subsea canned motor or magnetic drive pumps that eliminate the need for mechanical seals between the motor and pump shafts.

Typically, a seal-less pump design can be achieved using a canned motor pump or a magnetic coupling. Such seal-less pumps are disused in A User's Engineering Review of Sealless Pump Design Limitations and Features, T Hernandez, Proceedings of the Eighth International Pump User's Symposium, 1991, pp. 129-146 (the entirety of which is hereby incorporated by reference). Further exemplary details of a seal-less pump can be found, for example, in U.S. Patent Publication 2015/0354574, the entirety of which is hereby incorporated by reference.

While FIG. 2A provides for electric power for the SWIT and pumps via umbilical 201, the present technical advancement can use both hydraulic and electrical power, as electrical power can be provided via umbilical 201 and hydraulic lines can be included in umbilical 103.

The present technological advancement can also include a monitoring and performance optimization system for process (water injection) and equipment (SWIT, subsea chemical storage and injection, seal-less pumps, and control system). Performance of subsea equipment can be optimized, such as pump operating point (combination of power consumption, output head and flow rate) and at a system level, water injection pressure and/or rate can be optimized to get maximum hydrocarbon production rate. The performance optimization system can use control and communication circuitry, subsea pressure gauges, temperature gauges, flow meters, and/or vibration sensing instrumentation. The subsea sensors could all be optic-based with topside electronics. Control circuitry can be divided between the subsea and top side. This strategy can provide increased sensor reliability due to longer life of optic-based components and elimination of subsea electronics. All sensor measurements can be used in a feedback and/or feed-forward controlled mechanism using mechanical/process algorithms executed by a computer system to optimize process and equipment performance. Such a computer system can include control circuitry and/or one or more processors that are programmed to execute instructions stored in a computer readable memory in order to execute a method in accordance with the present technological advancement.

Typically, all subsea production or processing equipment are provided with a subsea control module to control functionality of valves included on the subsea equipment, wherein the subsea control module is communicatively coupled to a topside master control station. All subsea equipment (trees, manifolds, pumps, etc.) contain sensors for process variable (flow, temperature, pressure) measurements, wherein the sensors can be optically based.

FIG. 2B illustrates a system similar to that of FIG. 2A, wherein the separate umbilical 103 and power umbilical 201 in FIG. 2A are replaced with a combined power and communications cable 213. This simplified umbilical design is enabled by elimination of hydraulic, barrier fluid and chemical injection tubes. For this system, the control system can be all electric as hydraulic lines have been eliminated.

The combined power and communications cable 213 can provide electric power for a subsea all-electric control system (AC or DC power with transformer 205 as needed) with electronics and instrumentation that are configured for safe and efficient operation of water injection equipment (trees 110, water injection manifold 108, production manifold 109, pumps 203, SWIT 202, and a chemical storage and injection units 204). The subsea all-electric control system can include a master control station that is topside with electrical cables and electrically operated actuators for valve operations subsea, and can be communicatively connected to a pressure sensor disposed at least at the first or second seal-less subsea pump, a temperature sensor disposed at a water intake port of the seawater intake and treatment system, a flow sensor disposed downstream of a subsea manifold, and a vibration sensor disposed on any subsea equipment with moving parts (pump shafts, subsea jumpers, etc.). Each of the sensors can use reliable optics-based measurement principle and communicate with topside or shore-based electronic components via a fiber-optic communications cable.

The use of an all-electric control system will further simplify the umbilical 201 by eliminating the need for hydraulic fluid tubes and can improve the reliability of the subsea control system by eliminating complex components (such as directional control valves) in the conventional electro-hydraulic control systems. Further, fiber optic communications can be integrated within the control system to provide higher reliability (i.e. low noise) communications and increased bandwidth.

FIG. 2C illustrates a system similar to that of FIGS. 2A and 2B, wherein the system is equipped with only a single umbilical 215 for power and communications and production wells 217 are platform based.

The present technological advancement can be used in the management of hydrocarbons. As used herein, hydrocarbon management includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities.

The present technological advancement can also be embodied as a method to extract hydrocarbons. The steps of this method are not necessarily performed in the order recited herein and one or more steps can be performed simultaneously. Step 301 can include storing a chemical in a subsea storage unit. Step 302 can include treating seawater with a seawater intake and treatment system, wherein the treating includes taking in seawater with the seawater intake and treatment system and chemically treating the seawater with the chemical stored in the subsea storage unit, and the treating includes using a first subsea seal-less pump to transfer the chemical from the subsea chemical storage unit to the seawater intake and treatment system. Step 303 can include boosting pressure, with a second seal-less subsea pump, of the chemically treated seawater received from the seawater intake and treatment system. Step 304 can include injecting the chemically treated seawater into a seabed with a water injection manifold that receives the chemically treated seawater at the boosted pressure. Step 305 can include providing power (hydraulic and/or electric for electric or electro-hydraulic controls for all equipment) to the seawater intake and treatment system, the first subsea seal-less pump, the second sub-sea seal-less pump, and the water injection manifold. Step 306 can include extracting hydrocarbons from a well that is assisted by the injecting of the chemically treated seawater into the seabed via optimized performance. Such optimized performance can be controlled via a diagnostic/prognostic/optimization computer processor.

Some exemplary benefits of using the present technological advancement can include: elimination of flowline (CAPEX reduction) from the host to the injection well and associated corrosion inhibition costs (OPEX reduction); smaller topside footprint by moving injection equipment including pump(s) and water treatment system to the seabed (CAPEX reduction); simplified umbilical design by eliminating the need for injection chemicals (for corrosion inhibition and water treatment), hydraulic and barrier fluid tubes (CAPEX reduction); and higher reliability and lower maintenance requirements through simplified umbilical design, use of seal-less pumps and all-electric control system (OPEX reduction).

While embodiments of the present technological advancement may be described as having two seal-less pump, the present technological advancement can be implemented with just one seal-less pump or multiple seal-less pumps. Moreover, pumps other than seal-less pumps could be used with the present technological advancement.

The present techniques may be susceptible to various modifications and alternative forms, and the examples discussed above have been shown only by way of example. Indeed, the present techniques include all alternatives, modifications, and equivalents falling within the spirit and scope of the appended claims. While the present technological advancement has been explained via multiple examples, features from these examples may be combined as would be recognized by those of ordinary skill in the art. The present techniques are not intended to be limited to the particular examples disclosed herein.

### REFERENCES

The following references are hereby incorporated by reference in their entirety: U.S. patent publications 2015/0354574, 2016/0186759, 2015/0326094, 2015/0316072; 2015/0090124, 2013/0206423, 20100116726, 2009/0077835, 2005/0034869, and 2004/0256097; U.S. Pat. Nos. 8,534,364, 7,093,661, and 6,893,486; European patent publication EP894182; International patent publications WO2015103017 and WO1999035370; “Raw water reservoir injection moves to the seabed,” Offshore Magazine, Jan. 1, 2000; “Treating and Releasing Produced Water at the Ultra Deepwater Seabed,” 2012 Offshore Technology Conference, Daigle et al., and “Subsea Water Intake and Treatment—The Missing Link?”, SPE News Australasia, Eirik Dirdal, 17 Jan. 2014.

What is claimed is:

1. A subsea reservoir pressure maintenance system, comprising:
a subsea chemical storage unit;
a seawater intake and treatment system that takes in seawater and chemically treats the seawater with a chemical stored in the subsea chemical storage unit, wherein a first subsea seal-less pump transfers the chemical from the subsea chemical storage unit to the seawater intake and treatment system;
a second seal-less subsea pump that boosts pressure of the chemically treated seawater received from the seawater intake and treatment system; and
a water injection manifold that receives the chemically treated seawater at the boosted pressure and injects the chemically treated seawater into a seabed.

2. The system of claim 1, further comprising: an electrical power system that supplies electrical power to the seawater intake and treatment system, the first subsea seal-less pump, the second sub-sea seal-less pump, and the water injection manifold.

3. The system of claim 1, wherein the seawater intake and treatment system and the subsea chemical storage unit are disposed on the seabed.

4. The system of claim 1, further comprising a communication system that includes a fiber-optic communication cable between a top-side or shore-based hydrocarbon facility and at least the seawater intake and treatment system.

5. The system of claim 1, further comprising an all-electric control system that operates subsea equipment, including the seawater intake and treatment system, a pump, a tree, and a manifold.

6. The system of claim 1, further comprising a single umbilical, which houses an all-electric control system cables, power cables and the fiber-optic communication cables, that connect to a top-side or shore-based hydrocarbon facility.

7. The system of claim 6, further comprising a pressure sensor and vibration sensor disposed at least at the first or second seal-less subsea pump, and a temperature sensor disposed at a water intake port of the seawater intake and treatment system, a flow sensor, wherein each makes optical measurements and communicates with electronic components via the fiber-optic communications cable to the top-side or shore based hydrocarbon facility.

8. The system of claim 7, further comprising a processor that receives measurements from the pressure sensor, the temperature sensor, the flow sensor, and the vibration sensor and uses the measurements in a feedback or feed-forward control process to control performance of the seawater intake and treatment system.

9. The system of claim 1, wherein the first seal-less pump and the second seal-less pump are different seal-less pumps.

10. The system of claim 1, wherein the first seal-less pump and the second seal-less pump are a same seal-less pump.

11. A method, comprising:
storing a chemical in a subsea storage unit;
treating seawater with a seawater intake and treatment system, wherein the treating includes taking in seawater with the seawater intake and treatment system and chemically treating the seawater with the chemical stored in the subsea storage unit, and the treating includes using a first subsea seal-less pump to transfer the chemical from the subsea chemical storage unit to the seawater intake and treatment system;
boosting pressure, with a second seal-less subsea pump, of the chemically treated seawater received from the seawater intake and treatment system; and
injecting the chemically treated seawater into a seabed with a water injection manifold that receives the chemically treated seawater at the boosted pressure.

12. The method of claim 11, further comprising controlling subsea equipment with an all-electric control system.

13. The method of claim 11, further comprising: using a fiber optics communication system to communicate between topside equipment and subsea equipment.

14. The method of claim 13, further comprising measuring variables using optic based sensors.

15. The method of claim 11, further comprising: providing electrical power, with an electrical power system, to the seawater intake and treatment system, the first subsea seal-less pump, the second sub-sea seal-less pump, and the water injection manifold.
